(19) United States
(12) Patent Application Publication
(10) Pub. No.: US 2010/0214128 A1
(43) Pub. Date: Aug. 26, 2010

(54) AUTOMATIC CONTROLLED PRE ALLOTED PARKING SYSTEM

(75) Inventors: Rajeshkumar Hariprasad Acharya, California, CA (US); Hiren Prabhakarbhai Tharkkar, Grandhinagar (IN)

Correspondence Address: H K Acharya & Company, Inc., 2123 Stanford Avenue, Mountain View, California, CA, 94040, US

(73) Assignee: NANOLAND LIMITED, AHMEDABAD, GJ (IN)

(21) Appl. No.: 12/530,210

(22) PCT Filed: May 24, 2007
(86) PCT No.: PCT/IN2007/000212

§ 371 Date: Feb. 4, 2010

(30) Foreign Application Priority Data
Mar. 20, 2007 (IN) 512/MUM/2007

(51) Int. Cl. G08G 1/14

(52) U.S. Cl. 340/932.2

(57) ABSTRACT

Parking system is useful to manage the multistory parking lot and the system is able to display a current parking situation of the parking lot and efficiently guide drivers to select the parking space from the available parking space in parking lot at the time of entrance. Peoples chose their parking space form the available parking space, which is displayed on information display screen. The selected space coordinated data are disable form the stored database at the entrance computer. Barcode generator is connected with the entrance computer to generate the unique barcode for each parking space on entry card. Barcode reader read the barcode print on the entry card and mach with radio frequency tag signal with RF tag contain with each parking space. Alarm system is attached with this parking system to generate the sound in case of any mismatching of barcode. Existence computer system record the existed vehicle space coordinated data and synchronized the same data into the entrance computer system database.

### FIELD OF THE INVENTION

The present invention relates to automatic controlled pre allotted parking system and more particularly a management method that is able to display a current parking situation of the parking lot and efficiently guide drivers to find an available parking space.

### BACKGROUND OF THE INVENTION

To park the car is always a very big problem for those people who live in the metro city because of the lack of the parking spaces. Therefore the commercial parking lot is developed at mostly at airport, railway stations, and commercial complex and at big shopping moles to solve the problem. However if the parking lot does not have an efficient management system, drivers experience difficulty in finding an available position. These problems are particularly evident in town centers and in areas with a high density of traffic making it necessary to introduce structured systems to regulate access and to control parking generally based on the allocation. If any management system is not applied at these parking lots, most of the peoples are park their vehicles at any available space in the parking lot, so the current states at the entrance is not updated. In the multi floor parking lot, it is difficult to visitor to know about where the free space is available in the parking lot. In the conventional management method is to hire human staff that go around and inspect the entire parking lot, and then direct the drivers to a proper position. Obviously, such low efficiency management method uses up significant human resources and time, which increase the management cost of parking lot. To overcome above limitation present invention “AUTOMATIC CONTROLLED PRE ALLOTTED PARKING SYSTEM” is applied at parking lot.

### SUMMARY OF THE INVENTION

The main object of the present invention is to provide a management method and system for a parking lot to show the current status of the parking lot and guide the driver to an available free parking space.

To achieve the objective, the management method is performed by the following space. First of all define all coordinate data of the parking space. Then sense a current status of each parking space to recognize whether the parking space is available or not with the help of radio frequency tag. Then collect all the using status of the all parking spaces and display the collected using status at the entrance of the parking lot. All the free spaces are displacing on teach screen display. When visitor select the free space from the currently available database, barcode generator generates barcode. Barcode contains with entry date, entry time, radio frequency tag for selected coordinate data of the parking space.

Furthermore the automatic controlled pre allotted parking system includes with multiple radio frequency sensor, which indicate the free parking space on parking lot. Barcode generator is applied to detect current statuses of the parking space. Entry computer connected with the parking space coordinated database to gather all the using statues of the parking spaces in the parking lot so that the using status of each parking space is individually shown on the information display board. When the visitors select their space form the coordinate database through the touch screen, the selected coordinate data is disabling at the entrance information display database screen. Barcode generator generates barcode on entry card. Entry card contains entry date, entry time, selected parking space co-ordinate data into barcode format and radio frequency tag to sense the coordinated space location. When the visitor enters with the entry card at the selected parking lot space, radio frequency tag sense and match with the selected parking space. In case of miss-match of this tag signal, alarm system is activated, which indicates that the vehicle is not parked at selected/allotted parking space. When the vehicle is exit for the existence then the parking coordinated data is again entered into the free parking space coordinated database at entry computer.

All objectives, advantages and novel features of the invention will become more apparent from the following detailed description and with the help of the enclosed drawings, in which:

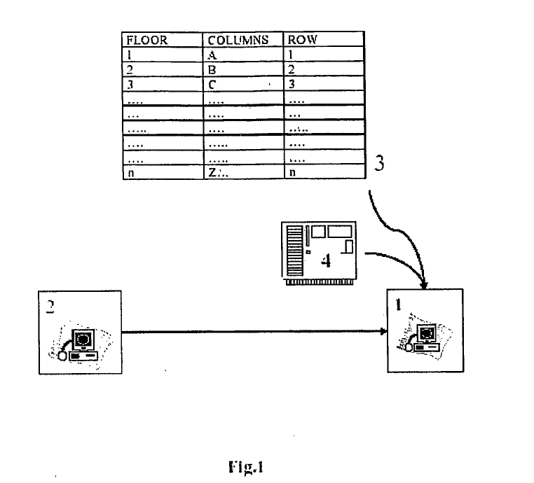

FIG. 1 represents a block diagram of a management system for a parking lot of the present invention.

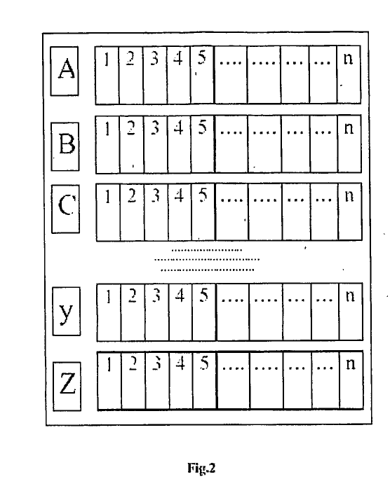

FIG. 2 a schematic view of a parking space of the present invention.

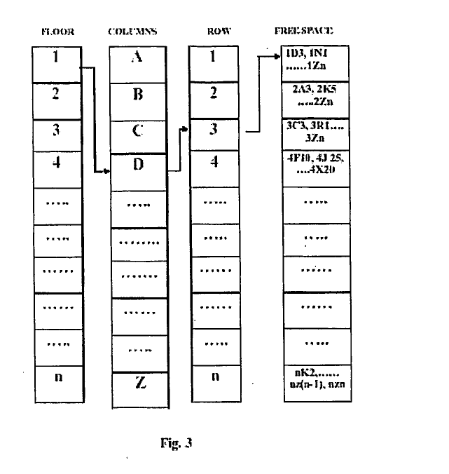

FIG. 3 display screen for free parking space of the present invention.

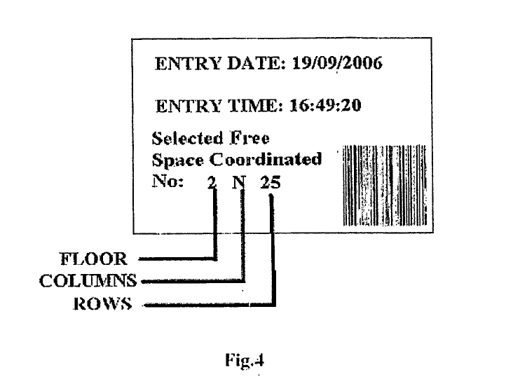

FIG. 4 display data on entry card.

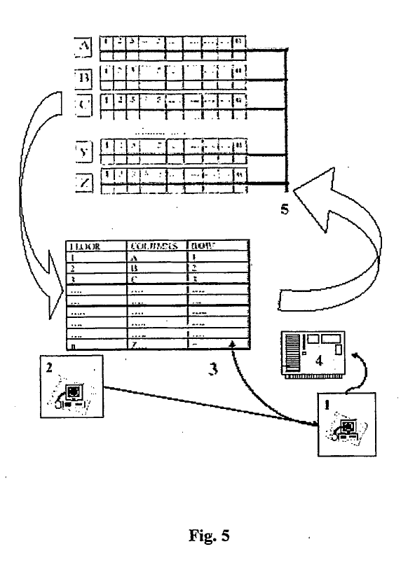

FIG. 5 Block diagram of parking system.

The present invention is a management method for a parking lot having multiple parking spaces, the method comprising the following steps: defining coordinate data of the parking spaces to recognize whether the parking space is available, gathering all the using statues of the all parking spaces and displaying the gathered using statues at the entrance of the parking lot and a guiding a vehicle that enters the parking lot to find an available parking space.

The forgoing method is performed by a automatic controlled pre allotted parking system. With reference to FIG. 1 the parking system includes barcode generators, a computer include with coordinated data, an information display board what is placed at the entrance of the parking lot and multiple barcode reader at each parking space.

The entry computer (1) is connected with barcode generator (2) and current information display touch screen (3). First of all define space coordinate data of the parking space are entered into the computer database. The information display touch screen (3) connects to the entry computer (1) to show the current situation of the parking lot. The information display touch screen (3) is designed to accord with the arrangement of all parking spaces in the parking lot, so that the situation of each parking space is individually shown on the touch screen (3).

When the vehicle entry at the entrance of the parking lot. All the available free space indicated coordinated data are display of information display touch screen (3), when the entered person select the free space form the available parking lot, the coordinated indicated data are disable form the main database which is stored in to the entry computer (1). The same coordinated data are print on the entry card (4). The coordinated data are in bar code format, which is generated by the barcode generator (2). Entry card (4) includes the data i.e. entry date, entry time, selected parking space indicated coordinated data in barcode format and radio frequency Tag. When the visitor entered into the parking lot with entry card (4) and reach at the selected parking space in the parking space. Radio Frequency tag is provided at each parking space, which match with the radio frequency tag on entry card for each parking space. If both the above signals are not match alarm system is activated in case of miss match. which indicates that the parked vehicle is not park as pre selected/allotted parking space. When the vehicle is exists from the existence the space coordinated data are again entered into the main database at entry Computer, and then the indicated same coordinated data are display on information display touch screen (3). The entry computer (1) is control the status data of the free parking space and the information display touch screen (3) based on the available free parking space. Furthermore since the status of each parking space is shown on the information display touch screen (3).

The present invention is used to overcome the problem wherein in a multistory parking lot where huge parking space is available and it is required to display available free space at the entrance of each parking lot. Information obtained from the computer database which is already stored into the computer. The information database is automatically updated time to time and the output space coordinated data are synchronized with entrance computer database. The updated information is also displayed on information display screen. Information of a parking lot empty space and guide information to the free space are visually display on information display screen.

The present invention is to provide a management method and system for a parking lot to show the current status of the parking lot and guide the driver to an available parking space

We claim:

1. AUTOMATIC CONTROLLED PRE ALLOTTED PARKING SYSTEM comprising with entry computer (1), existence computer (2), information display touch screen (3), barcode generator (4) and radio frequency tag sensor.

2. AUTOMATIC CONTROLLED PRE ALLOTTED PARKING SYSTEM as claimed in claim 1 wherein entry computer (1) contains with all space coordinated database.

3. AUTOMATIC CONTROLLED PRE ALLOTTED PARKING SYSTEM as claimed in claim 1 wherein information display touch screen (3) is connected with entry computer (1) to display all space coordinated database on information display touch screen (3).

4. AUTOMATIC CONTROLLED PRE ALLOTTED PARKING SYSTEM as claimed in claim 1 wherein barcode generator is connected with entry computer (1) to generate barcode on entry card.

5. AUTOMATIC CONTROLLED PRE ALLOTTED PARKING SYSTEM as claimed in claim 1 wherein first two letter of the space coordinated database indicate the number of floor;
third and forth letter of the coordinated database indicate the number of column;
fifth and sixth letter of the coordinated database indicate the number of row.

6. AUTOMATIC CONTROLLED PRE ALLOTTED PARKING SYSTEM as claimed in claim 1 wherein barcode generator (3) generates unique barcode for each selected parking space on entry card.

7. AUTOMATIC CONTROLLED PRE ALLOTTED PARKING SYSTEM as claimed in claim 1 wherein entry card contains the data i.e. entry date, entry time, space coordinated data in barcode form and radio frequency tag.

8. AUTOMATIC CONTROLLED PRE ALLOTTED PARKING SYSTEM as claimed in claim 1 wherein radio frequency sensor is provided at each parking space to sense for each parking space coordinated data.

9. AUTOMATIC CONTROLLED PRE ALLOTTED PARKING SYSTEM as claimed in claim 1 wherein alarm system is connected with radio frequency sensor at each parking space location.

10. AUTOMATIC CONTROLLED PRE ALLOTTED PARKING SYSTEM as claimed in claim 1 wherein existence computer system (2) collect the data of existed vehicle and pass the same data into the entrance computer system database (1).

11. AUTOMATIC CONTROLLED PRE ALLOTTED PARKING SYSTEM substantially as herein described with reference to the foregoing description and the accompanying drawings
